(19) United States
(12) Patent Application Publication
(10) Pub. No.: US 2008/0238079 A1
(43) Pub. Date: Oct. 2, 2008

(54) Memory diary book

(76) Inventor: Ricardo J. Whyte, Loma Linda, CA (US)

Correspondence Address: RICARDO J. WHYTE, 25430 SONORA-LOOP, LOMA LINDA, CA, 92354, US

(21) Appl. No.: 11/731,858

(22) Filed: Apr. 2, 2007

(51) Int. Cl. B42D 1/00; B42D 3/00; B42D 9/00; G09B 19/08

(52) U.S. Cl. 281/3.1; 281/18; 281/36; 281/42; 283/45

(57) ABSTRACT

A memory book or diary intended for recording pleasant memories for sharing in the future. This book may include dedications, suggestions, encouragement, guidance, advice, and storage pouches to promote and support relationships. The book may also include clinical or problem solving tools or techniques to improve a relationship. The book is for immortalizing pleasant memories, sentiments, events, gifts exchanged or memories shared. The book can be shared by partners, siblings, parents, pet owners, and are ideally suited to document the beginning of relationships, marriages, pet owners or parenthood. The book can be shared in the future to relive the memories captured in the book.

### FIELD OF THE INVENTION

This invention relates to a diary type of memory book. More particularly, the present invention relates to a diary type of book where the book is intended to be given to couples where each couple, daily, writes pleasant memories their partner does, says or gives to them. The other benefit is that in the future the partners can share the pleasant memories of the past days.

### BACKGROUND OF THE INVENTION

The prior art discloses many examples of patents for books that are intended for people to write into, but none providing the combination of features disclosed and claimed herein.

U.S. Pat. No. 1,161,580 issued to I. R. Allen on Nov. 23, 1915 discloses a scrapbook. This patent is for a scrapbook for the storage of items such as pictures and mementoes. While this product provides a storage place for the items, the items are placed into the scrapbook in a random fashion and the scrapbook is intended to store items. The patent does not provide a specific place for writings, nor does it provide for daily writings or offer encouragement or suggestions for the writing or memories.

U.S. Pat. No. 4,793,634 issued to Alloggiamento on Dec. 27, 1988 discloses an original perpetual diary calendar. This patent provides an erasable section(s) that allows sections of the diary to be erased and different information to be placed onto the pages. While this product provides a place for writings, the writings are intended to be erased and not stored for future sharing. The patent does not allow for storage of items in the diary. The patent does provide for daily writings or offer encouragement or suggestions for the writing or memories.

U.S. Pat. No. 5,374,083 issued to Slocomb on Dec. 20, 1994 discloses a variable period diary. This patent provides flexibility for an author to use as much or as little of the diary as needed to store writings. The patent does not allow for storage of items in the diary. The patent does provide for daily writings or offer encouragement or suggestions for the writing or memories.

U.S. Pat. No. 6,347,811 issued to Bianco Feb. 19, 2002 discloses a structure of a diary of high practicality of use. This patent provides for a structured writing. This patent forces a person to write in a structured manner and does not allow free writing for maximum creativity. The patent does not allow for storage of items in the diary. The patent does provide for daily writings or offer encouragement or suggestions for the writing or memories.

U.S. Design Pat. No. D278,352 issued to Wenstrom et al. Apr. 9, 1985 discloses a diary. This patent is basically a design of a diary that includes a lockable function to prevent others from reading the diary. While this patent allows for writings it contradicts the purpose of the proposed application that is intended to share the writings and memories. The patent does not allow for storage of items in the diary. The patent does provide for daily writings or offer encouragement or suggestions for the writing or memories.

What is needed is a memory type diary that is intended to document pleasant memories, for the purpose of sharing the memories with a friend or loved one in the future. This diary would aid people with suggestions and ideas that will further promote the immortalizing of the relationship. The proposed diary provides this solution by providing a simple to use book of encouragement that help promote the relationship and provides storage of keepsakes that can be shared in the future. The proposed device satisfies these needs.

### BRIEF SUMMARY OF THE INVENTION

One of the objects of this invention is to provide a new and improved memory book or diary that provides a year's worth of pages intended for writing pleasant memories each day for a person to write about their partner.

Another object of the invention is providing suggestion pages that provide encouragement, guidance, advice, and ideas for writings.

Another object of the invention is to provide a diary or memory book that is intended to provide only pleasant memories or sentiments regarding one's partner.

Another object of the invention is to provide a dedication page within the book to write a dedication to the author's partner regarding the reason or event that the book is being given for.

Another object of the invention is to provide a pocket or storage location within the book to allow for people such as husband and wife, life partners, boyfriend/girlfriend, father/daughter, father/son, brother/sister, mother/son, mother/daughter, or any one or two people to immortalize memories for another person or for themselves.

Another object of the book is to provide memories for someone who is away example in the military or college.

Another object is the book is to provide memories of new-born baby, adopted child, first year of marriage, beginning of a relationship, citizenship/immigration or for a pet.

Another object of the book is to provide advertising or coupons for companies that offer products or services that encourage and promote relationships.

Another object of the book is to dedicate the book to someone to celebrate a new wedding, baby or some event that signifies a starting point for remembering events.

Yet another object of the invention is to provide a time capsule book that allows couples to store memories for them to recall at a future time.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view the book of one particular embodiment.

FIG. 2 shows two potential pages from the memory book.

FIG. 3 shows two potential pockets for storing tangible items.

FIG. 4 shows a potential suggestion page to give guidance for writing in the book.

FIG. 5 shows a coupon page for products or services that may be valuable for author and may further promote the relationship.

### DETAILED DESCRIPTION

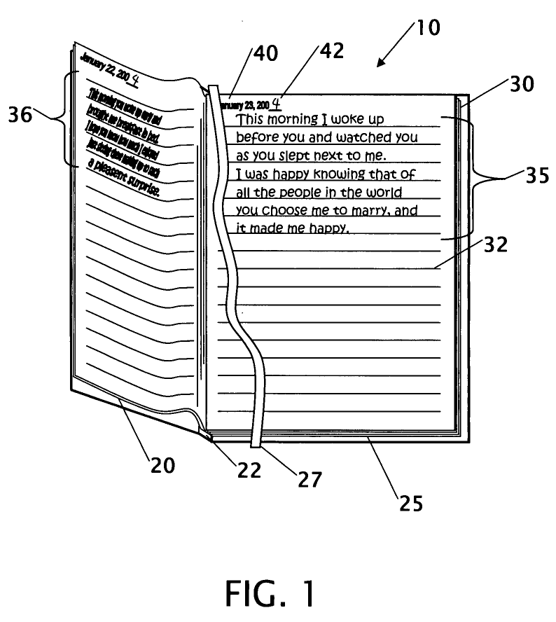

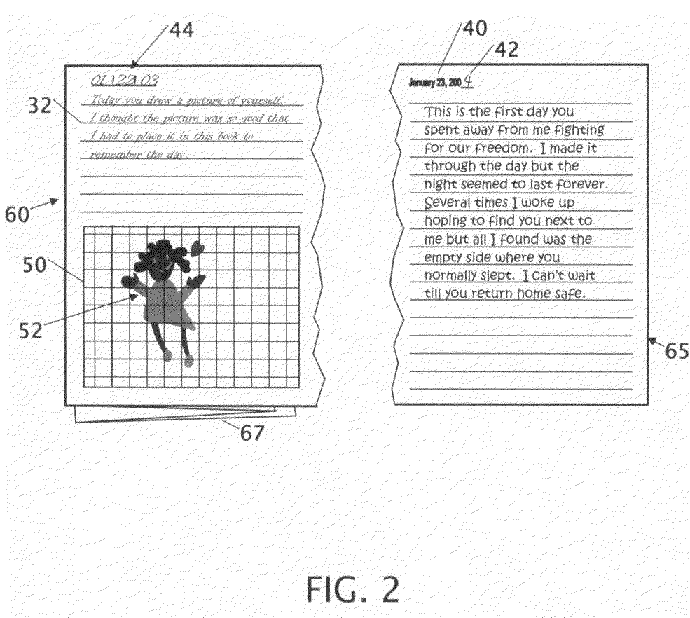

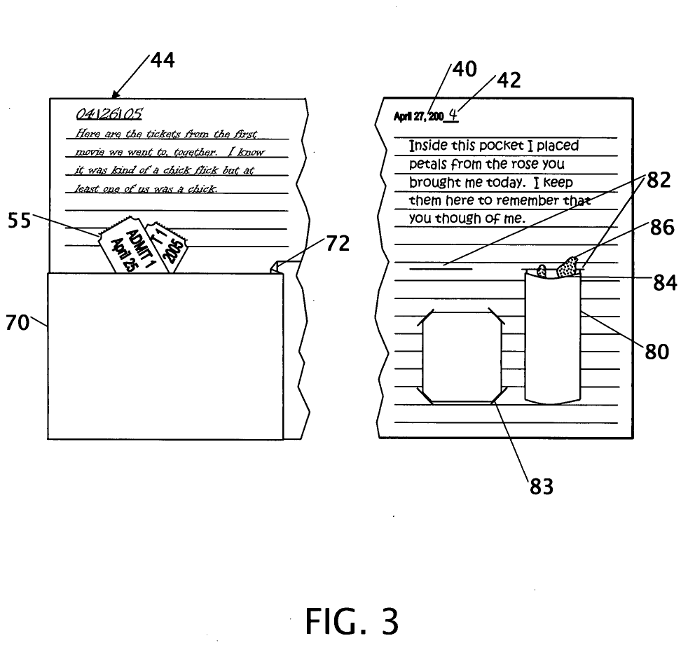

Referring to FIG. 1, there is shown an isometric view of the book 10 of one particular embodiment. In the preferred embodiment the book is set up as a diary spanning a year's time or 365 days. This span allows the receiver the opportunity to write, store, immortalize, chronicle, document or record in a written manor for future sharing with someone. While the span is disclosed in the preferred embodiment as a year, the period of time may be shorter or longer than the one-year period. As an example the book may be for a vacation, anniversary, or honeymoon period of a weekend, week, weeks, month or months in duration. It is also contemplated that the duration can be more than a year, or can be an appended book that allows sections to be added or removed to allow the book to be useable over an infinite period of time. The construction of the book consists of similar constructed book, journals or diaries including a cover front 20, back cover 25 and a spine 22 that binds the pages to the book. A bookmark 27 is shown that is movable to any of the pages. While only a ribbon type bookmark is shown, the bookmark could also be made from paper, cloth or leather based material. The book may also be fabricated in a spiral or binder type cover that holds the pages in the book. It is also contemplated that the cover of the book can be hard or soft covered and be further bound with cloth, leather or other covering material. The pages 30 are configured for writing or drawing on both sides of the page, but the pages can be written on only one side of each page. The pages can be pre-printed with the date 40 and may include the year or a portion of the year 42. The date may be shown leaving spaces for the author to manually enter the date as shown item 44 in FIGS. 2 and 3.

The pages of the book may contain pre-lined 32 pages that allow the author to write information 35 and 36 on the pages or an open space may be placed on the page to allow the author to draw a picture shown as item 52 in FIG. 2. It is also contemplated that one or more of the pages can be unfolded 67 to create a page that is larger in size than the cover of the book.

Referring now to FIG. 2 that shows two potential pages from the memory book. Page 65 is shown as a lined page allowing the person to write text. Page 60 is shown with combination lined page area 32 and a drawing area 50. The drawing area is shown here with a grid pattern drawn in, but the drawing area may be blank, or may further include pattern or colors. The drawing area of this page shows a drawing 52 that may have been drawn by a child for a parent. It is further contemplated that one or more pages be completely blank to allow for a larger drawing, or for the placement of a picture 50. The format of the date shown as item 44 allows the book to be started at any particular point in time allowing flexibility of the author to skip a day, or to use multiple pages in a single day. The date shown as item 40 fixes the author into the use of one page at a particular date.

Referring to FIG. 3 shows two potential pockets for storing tangible items. The pockets allow for the storage of item memorabilia that can be described, but also allow the storage of the item(s) for greater memory or sentiment. As an example, tickets 55 from a particular event can be placed or stored in the pocket. The tickets may also be stapled or glued to the page to prevent loss or movement. A pocket 70 can be added or incorporated into the page(s) for the storage of these items. The pocket may also be pleated 72, folded, or expanded to allow for items of various thicknesses to be places within the pocket. It is also contemplated that the pockets can be included with the book, but not installed in a particular location, and the user can move or re-position the pocket(s) to a location that is most beneficial. In the configuration of the pocket 80, the pocket is slid into one or more slits 82 located on each page. Some pages include slots that are diagonal 83 to the edges of the pages for retaining photographs, cards or tickets. In the preferred embodiment the pocket is transparent so the item(s) placed inside the pocket are visible, but the pocket can also be made from the same or similar material the book pages are made from. The slits on the page allow a tab on the pocket to be slid into the slit of the page to retain the pocket onto the page. This pocket is basically a flat tubular pocket that is open on one side 84 to allow item(s) 86 to be placed within the pocket. In this figure the items are shown at petals from a flower that are stored.

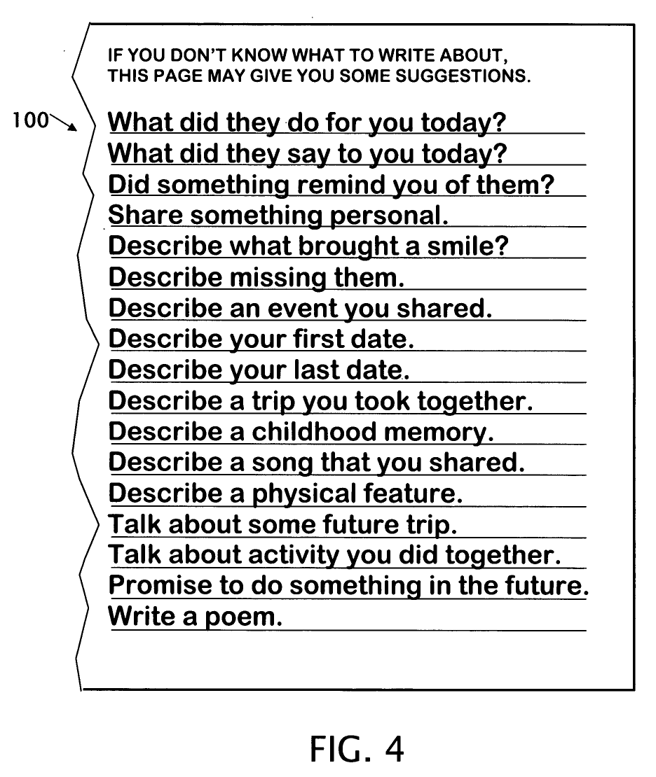

Often people are at a loss regarding what to write. To assist people with writers block, a page shown as FIG. 4 that provides some potential suggestions page 100 to give guidance for writing in the book. This page may stimulate thoughts about something to write, or encourage the author to write more frequently. This page offer suggestions regarding events shared, things said, gifts exchanged. It also provides thought that allow the person to elaborate about previous dates, trips, songs, or things that made the author happy.

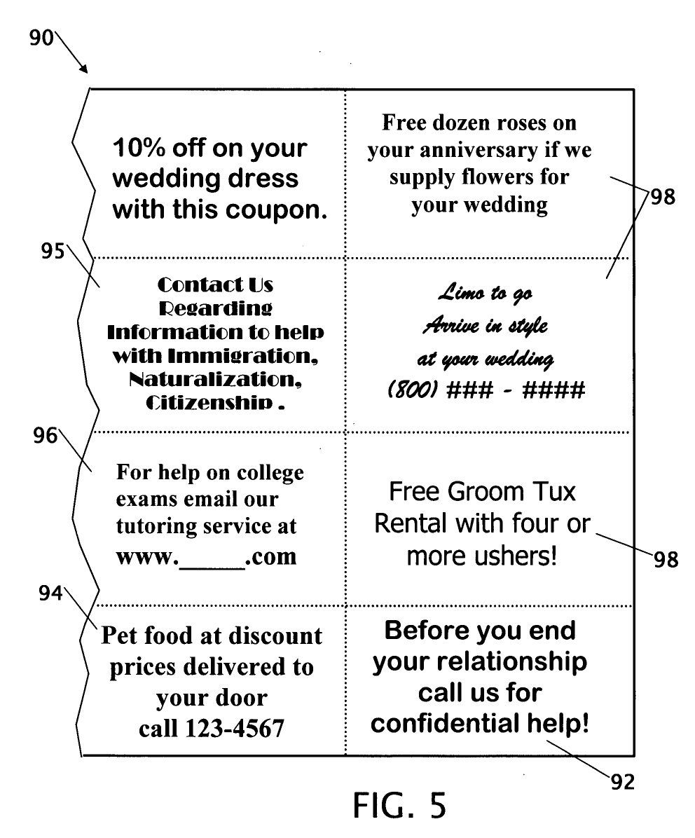

Another feature of the book is to provide a coupon type page 90 that offered products or serves to assist or help the author or a couple with their relationship. The coupons shown in FIG. 5 provide products or services that may be valuable for author and may further promote the relationship. Another contemplated page may include marital tools that aid in working through the problems that face couples or partners 92. Some of the coupons may provide services that can give counseling or guidance to a troubled relationship or information on how to become a citizen or special help groups to matriculate into a foreign country. Other coupons may provide wedding products or services 98, citizenship/immigration 95, while other coupons may provide pet supplies 94 or college 96 tutoring.

The intent of this book is for the pleasant writings or drawings of text or figures of pleasant memories, thoughts or wishes that will be shared at a present or future time either with a partner or read by the author at a future time to remember the event(s) The book can be theme based such as wedding, graduation, dating, new child, new pet, military absence, college, citizenship/immigration, new relationships. A dedication page will be included that allows the author to dedicate the writing and drawings of the book. This dedication page may include the reason why the book is being dedicated or the event that begins the authoring of the book.

The book is shared between people such as husband and wife, life partners, boyfriend/girlfriend, father/daughter, father/son, brother/sister, mother/son, mother/daughter, or any one or two people to immortalize memories for another person or for themselves. The book may also provide a time capsule of events shared to allow couples to store memories for them to recall at a future time. Another contemplated embodiment or feature may include a voice chip that plays a recordable or pre-recorded message when the book is opened or moved in some way.

Thus, specific embodiments and applications for a diary memory book have been disclosed. It should be apparent, however, to those skilled in the art that many more modifications besides those described are possible without departing from the inventive concepts herein. The inventive subject matter, therefore, is not to be restricted except in the spirit of the appended claims.

1. A memory diary book comprising:
a plurality of pages bound between two covers;
indicia on the pages including lines;
a section of perforated pages for removal of all or a portion of the pages where the removed section included pre-printed or writable coupons that the author can elaborate on said writable coupon before they pass or exchange said writable coupon with others;
at least one movable pocket and at least one page with a plurality of slots for retention of said at least one movable pocket, photograph, ticket or card;
preprinted suggestive writings or illustrations that suggest and encourage the owner to enter their own information that will be shared or exchanged with one or more people to enhance a relationship.

2. The memory diary book as recited in claim 1 wherein said pages with slots have lines that run through the slotted area of said pages to allow writing or placement of pockets or items in said slots.

3. The memory diary book as recited in claim 1 further comprising at least one page with a repositionable pocket for storing memorabilia.

4. The memory diary book as recited in claim 1 further comprising started sentences to encourage the owner to expand extemporaneously using personal information upon the started sentences.

5. The memory diary book as recited in claim 1 further comprising a preface section for writing a dedication for the book when it is given as a gift.

6. The memory diary book as recited in claim 1 further comprising at least one page having both a pocket and lines for the owner to write text.

7. The memory diary book as recited in claim 1 further comprising an integrated bookmark that is movably placed between the pages.

8. The memory diary book as recited in claim 1 that is theme based for recording memories including birth, marriage, service, employment, religion, anniversary, holiday, vacation, college, pet, romantic, or relationship.

9. The memory diary book as recited in claim 1 further comprising pre-colored pages based upon the theme of the book.

10. The memory diary book as recited in claim 1 further comprises coupons for local advertising of items that are related to the purpose of the book.

11. The memory diary book as recited in claim 1 further comprising a cover that is uniquely decoratable by the owner or provider of the book.

12. The memory diary book as recited in claim 1 further includes a lock or securing element to keep the book closed.

13. (canceled)

14. (canceled)

15. The memory diary book as recited in claim 1 further comprising at least one drawing area for entering a freehand picture.

16. The memory diary book as recited in claim 1 further comprises a storage area for scissors, glue and or marking tools.

17. The memory diary book as recited in claim 1 further comprising a margin for entering the date, time and or place where the recorded memory is taking place.

18. The memory diary book as recited in claim 1 further comprising colored and or patterned pages that are removable and reconfigurable for placement or gluing onto the cover or onto other pages.

19. The memory diary book as recited in claim 1 further comprising at least one page that can be folded out to increase the size of the page beyond the size of the covers.

20. The memory diary book as recited in claim 1 wherein said movable pocket on said plurality of slots is transparent to allow viewing stored items through said transparent window.
